(19) United States
(12) Patent Application Publication
(10) Pub. No.: US 2013/0284286 A1
(43) Pub. Date: Oct. 31, 2013

(54) Systems and Methods for Providing Natural Gas Fueling Stations

(71) Applicants: Scott Edelbach, Rochester, MN (US); Jeff Lucero, Fontana, CA (US)

(72) Inventors: Scott Edelbach, Rochester, MN (US); Jeff Lucero, Fontana, CA (US)

(21) Appl. No.: 13/873,051

(22) Filed: Apr. 29, 2013

Related U.S. Application Data
(60) Provisional application No. 61/639,715, filed on Apr. 27, 2012.

(51) Int. Cl. B60P 1/43; B60P 1/00; F17C 1/00

(52) U.S. Cl. CPC B60P 1/43; F17C 1/00; B60P 1/00
USPC 137/351; 414/812; 414/813

(57) ABSTRACT

A natural gas storage and transport system comprises a housing having a compressor and a natural gas storage vessel in fluid communication with the compressor. The housing can have one or more guide members for enabling the housing to be loaded onto and removed from a transport vehicle removably supporting the housing.

### CROSS-REFERENCE

This application claims priority to U.S. Provisional Patent Application No. 61/639,715, filed Apr. 27, 2012, which is entirely incorporated herein by reference.

### BACKGROUND

Vehicles utilizing alternative fuel, such as natural gas (e.g., CH₄), may require fueling stations to refuel. Modular fueling stations, such as fueling stations for natural gas, have been developed for deployment in various areas. Some of these deployment techniques involve the use of specialized equipment and cost a great deal in time and money. In addition, in a traditional compressed natural gas (CNG) re-fueling station, bringing natural gas to the station site may involve receiving gas from a natural gas feeding pipeline, measuring the gas flow rate through a traditional gas metering plant, compressing gas up to a predetermined pressure (for instance, 250 bar) using a traditional compressor unit, and storing gas at storing gas vessels. The gas can be channeled to the station fuel pump and delivered at a 200 bar of pressure.

Such approaches may require the expenditure of considerable resources to install feeding pipelines, which may not be practical.

### SUMMARY

Recognized herein is the need for improved systems and methods for providing and/or deploying fueling stations vehicles using alternative fuel, such as natural gas.

An aspect of the present disclosure provides a natural gas storage system, comprising a housing having a compressor and a natural gas storage vessel in fluid communication with said compressor, said housing having one or more guide members for enabling the housing to be loaded onto and removed from a transport vehicle removably supporting said housing.

Another aspect of the present disclosure provides a method for depositing a natural gas storage system at a given location, comprising slidably removing at said given location said natural gas storage system from a support surface of a transport vehicle having said natural gas storage system, said natural gas storage system having a compressor and a natural gas storage vessel in fluid communication with said compressor.

Another aspect of the present disclosure provides a method for loading a natural gas storage system on a transport vehicle, comprising loading a natural gas storage system onto a transport vehicle in a time period of at most about 5 minutes.

Another aspect of the present disclosure provides a method for deploying a natural gas storage system from a transport vehicle for use at a given location, comprising unloading a natural gas storage housing from said transport vehicle at said given location and preparing the natural gas storage system for use at said given location in a time period less than or equal to about 10 minutes.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” or “FIGS.” herein) of which:

FIG. 1 shows an example of a refueling station provided, in accordance with an embodiment of the present disclosure;

FIG. 2 shows a top view of the refueling station of FIG. 1, in accordance with an embodiment of the present disclosure;

FIG. 3 shows a top view of the refueling station of FIG. 1, which shows a plurality of doors of the refueling station, in accordance with an embodiment of the present disclosure;

FIG. 4 shows a side view of a refueling station of FIG. 1, in accordance with an embodiment of the present disclosure;

FIG. 5 shows a front view and back view of a refueling station of FIG. 1, in accordance with an embodiment of the present disclosure;

FIG. 6 shows a perspective isometric view of a refueling station of FIG. 1, in accordance with an embodiment of the present disclosure;

FIG. 7 shows a perspective isometric view of the refueling station of FIG. 1, in accordance with an embodiment of the present disclosure;

FIG. 8 shows an exemplary vehicle that can be used in the deployment of a refueling station, in accordance with an embodiment of the present disclosure;

FIG. 9 provides an example of a refueling station that has been loaded onto a vehicle;

FIGS. 10A-10C schematically illustrate a method used to load a refueling station onto a transport vehicle, in accordance with an embodiment of the present disclosure;

FIG. 11 shows support members and tracks for use with loading and unloading a refueling station from a transport vehicle, in accordance with an embodiment of the present disclosure. The images at the left show an exploded view of an underside of the refueling station and tracks below the refueling station. The images at the right show a support member adjacent to the tracks; and

FIG. 12 shows an underside of a refueling station having the support members adjacent to the tracks, in accordance with an embodiment of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “natural gas” generally refers to a naturally occurring hydrocarbon gas or gas mixture. Natural gas may include methane (CH₄) and, in some cases, other hydrocarbons as well as impurities (e.g., CO₂). In an example, natural gas can include methane and up to about 20% of other hydrocarbons as well as impurities in varying amounts. Natural gas can be used as an important energy source in various applications, including heating, power generation, fuel for combustion engines and a chemical feedstock in the manufacture of products, such as, for example, plastics and commercially viable organic chemicals.

The term “compressed natural gas” generally refers to natural gas (e.g., CH₄) that has been compressed, such as to less than about 1% of the volume it occupies at standard atmospheric pressure.

The term “vehicle” generally refers to any device that is adapted to move from one point to another with the aid of an engine. A vehicle can include an internal combustion engine that operates on fuel, such as compresses natural gas.

The invention provides systems and methods for providing and/or deploying fuel (or refuel) stations, such as natural gas fuel stations. Such stations can be used to provide fuel for vehicles having internal combustions engines that operate on such fuels, such as natural gas. Various aspects of the invention described herein may be applied to any of the particular applications set forth below or in any other type of fuel storage and/or delivery setting. The invention may be applied as a standalone method or system, or as part of an integrated fuel storage and/or delivery system. It shall be understood that various aspects of the invention can be appreciated individually, collectively, or in combination with each other.

In some embodiments, integrated refueling stations are provided that include components necessary to store, transport and deliver natural gas at a designated location, such as a remote location. Refueling stations and transport vehicles of the present disclosure can advantageously enable natural gas to be delivered to a delivery location and installed for use, in some cases without the need for sophisticated equipment and expenditure of resources that may otherwise impede delivery of natural gas to the delivery location.

Refueling stations provided herein are configured for ready transport from a loading location to a delivery location. At the delivery location, a refueling station can be readily deployed and made available for use, such as fueling (or refueling). In some cases, the refueling station can be deployed for use at a delivery location in a matter of minutes or even seconds, thereby enabling the refueling station to be readily transported and made available for use at various locations, including remote locations.

### Natural as Transport and Storage Systems

An aspect of the present disclosure provides a natural gas storage and transport system, comprising a housing having a compressor and a natural gas storage vessel in fluid communication with the compressor. The housing has one or more guide members for enabling the housing to be loaded onto and removed from a transport vehicle that removably supports the housing.

In some cases, a guide member includes a roller. The roller may have various shapes and configurations, such as spherical or cylindrical. In an example, the roller is a wheel. In other cases, the guide member includes an engagement member that couples to a track or rail. The engagement member can be a wheel that couples to a track. The track can be provided on support surface of the transport vehicle.

The housing can have various shapes and sizes. For instance, the housing can be box-like, such as a square or rectangular housing. The housing can have a spherical, triangular, square or rectangular cross-section, or combinations or partial shapes (e.g., semi-circular) thereof. In an example, the housing is cylindrical. In another example, the housing is spherical. In another example, the housing is rectangular.

In some embodiments, the natural gas storage and transport system is a fueling station, which can be used for refueling purposes. The fueling station can be used for fueling and re-fueling devices that operate on natural gas, such as, for example, vehicles.

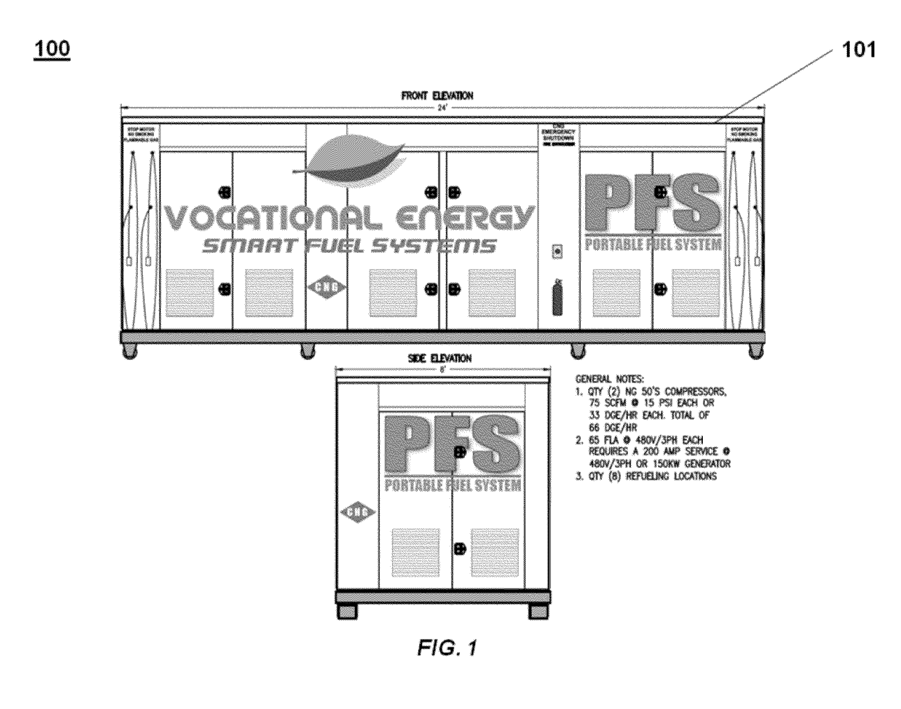

FIG. 1 shows a refueling station (or system) 100, in accordance with an embodiment of the present disclosure. The station includes a housing 101 that is rectangular in shape. The housing 101 has a plurality of doors to enable access to one or more interior portions of the housing 101. The refueling station can be used to store and transport various gases, such as natural gas. Such gases can be pressurized during storage and transport.

The refueling station 100 can have a length from about 1 feet (“ft”) to 50 ft, or 10 ft to 30 ft; a width from about 1 ft to 20 ft, or 4 ft and 12 ft; and a length from about 1 ft to 20 ft, or 4 ft and 12 ft. In an example, the refueling station 100 has a length of about 24 ft, width of about 8 ft, and height of about 8 ft. The refueling station 100 can have a weight from about 10,000 lbs to 30,000 lbs, or 15,000 lbs to 25,000 lbs. In an example, the refueling station 100 has a weight of about 16,000 lbs.

In some embodiments, the refueling station 100 has a footprint (length×width) of at least about 10 ft², 20 ft², 30 ft², 40 ft², 50 ft², 60 ft², 70 ft², 80 ft², 90 ft², 100 ft², 200 ft² , 300 ft², 400 ft², 500 ft², 600 ft², 700 ft², 800 ft², 900 ft², or 1000 ft².

The refueling station 100 includes one or more compressors for compressing natural gas to an elevated pressure, such as, for example, between about 0.13 bars and 310.26 bars, or 10 bars and 300 bars.

In an example, the refueling station 100 includes two compressors. Each compressor can operate at 50 horsepower (hp), and have a three phase 480/277 electric motor. Each compressor can compress natural gas at a rate of about 75 standard cubic feet per minute (SCFM).

The refueling station 100 can include eight outlets for supplying natural gas, which may be expanded to 20 outlets. Each outlet can include a channel (e.g., pipe, hose) in fluid communication with a natural gas storage vessel or compressor of the refueling station 100.

The refueling station 100 can supply natural gas at a rate of about 65 diesel gallon equivalent (DGE) or 72 gasoline gallon equivalent (GGE) per hour. In some cases, the refueling station 100 can supply natural gas at a rate of about 780 DGE in 10 hours or 1560 GGE in 12 hours.

The refueling station 100 can require a given area for installation at a designated site. In an example, the installation area is about 20 ft by 30 ft (600 ft²). In some embodiments, an installation area of at least about 10 ft², 20 ft², 30 ft², 40 ft², 50 ft², 60 ft², 70 ft², 80 ft², 90 ft², 100 ft², 200 ft², 300 ft², 400 ft², 500 ft², 600 ft², 700 ft², 800 ft², 900 ft², 1000 ft², or 10,000 ft² may be required. The installation area can include a support surface, such as a support surface formed of a polymeric material, metallic material, or composite material.

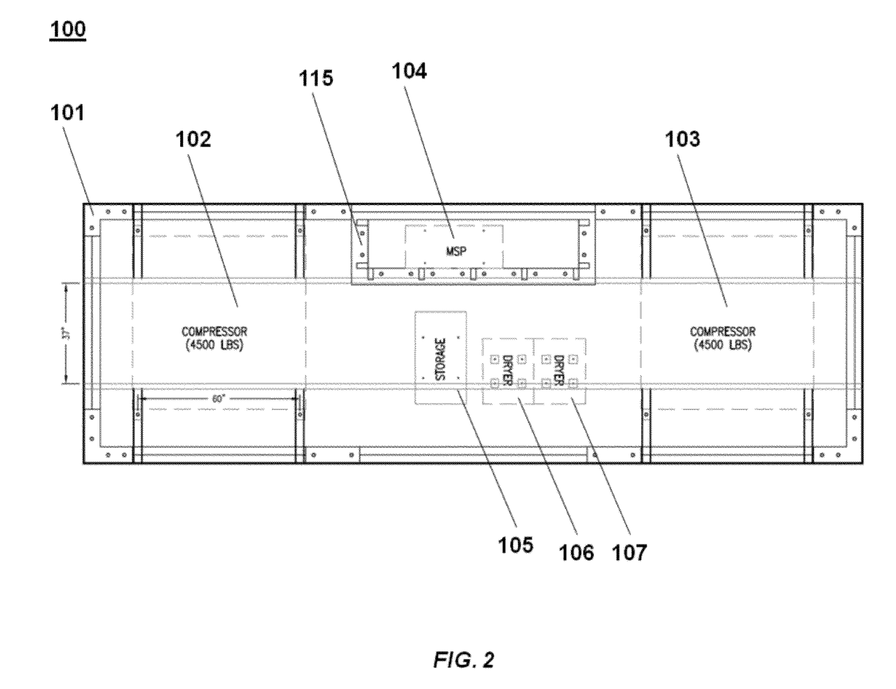

FIG. 2 shows a top view of the refueling station 100, in accordance with an embodiment of the present disclosure. The refueling station 100 includes a first compressor 102, second compressor 103, electronics 104 (e.g., control electronics), a natural gas storage vessel 105, a first dryer 106 and a second dryer 107. The natural gas storage vessel 105 is in fluid communication with one or both of the first compressor 102 and a second compressor 103. The first compressor 102 and second compressor 103 can compress natural gas for storage in the natural gas storage vessel 105. The electronics 104 is programmed to regulate various parameters associated with storing natural gas, such as, for example, regulating the rate at which natural gas is provided to or removed from the natural gas storage vessel 105, or regulating compressor power (e.g., starting or stopping compressors while attended or unattended).

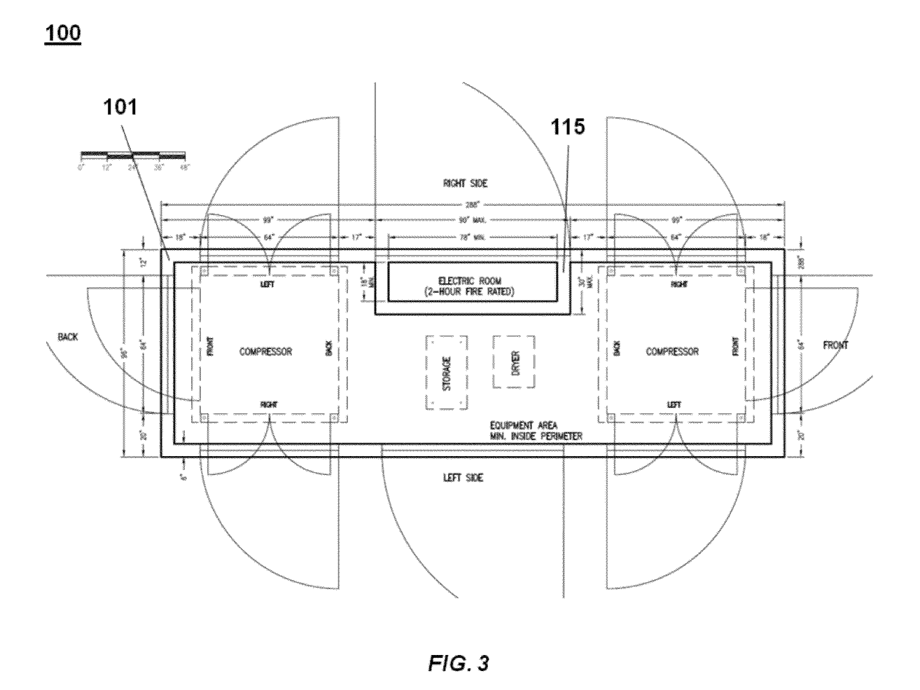

The compressors 102 and 103, electronics 104, natural gas storage vessel 105 and dryers 106 and 107 are enclosed in the housing 101. The housing 101 includes a plurality of doors for enabling access to the compressors 102 and 103, electronics 104, natural gas storage vessel 105 and dryers 106 and 107, as shown in FIG. 3. The electronics 104 is provided in an electric room of the refueling station 100. The electrical room is defined by an interior barrier 115 (see FIGS. 2 and 3). In an example, the electric room is two-hour fire rated.

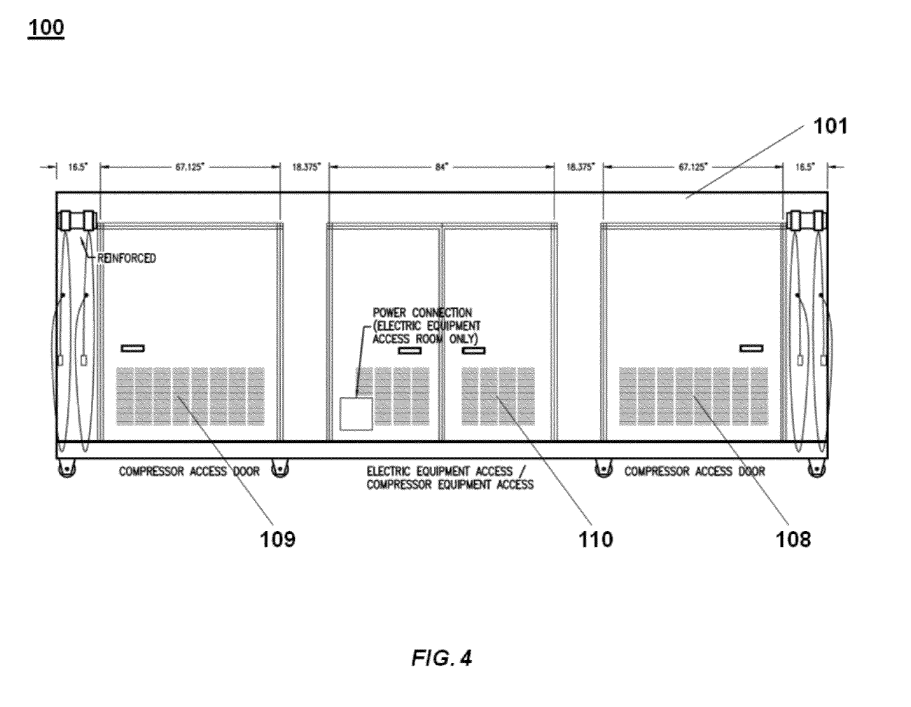

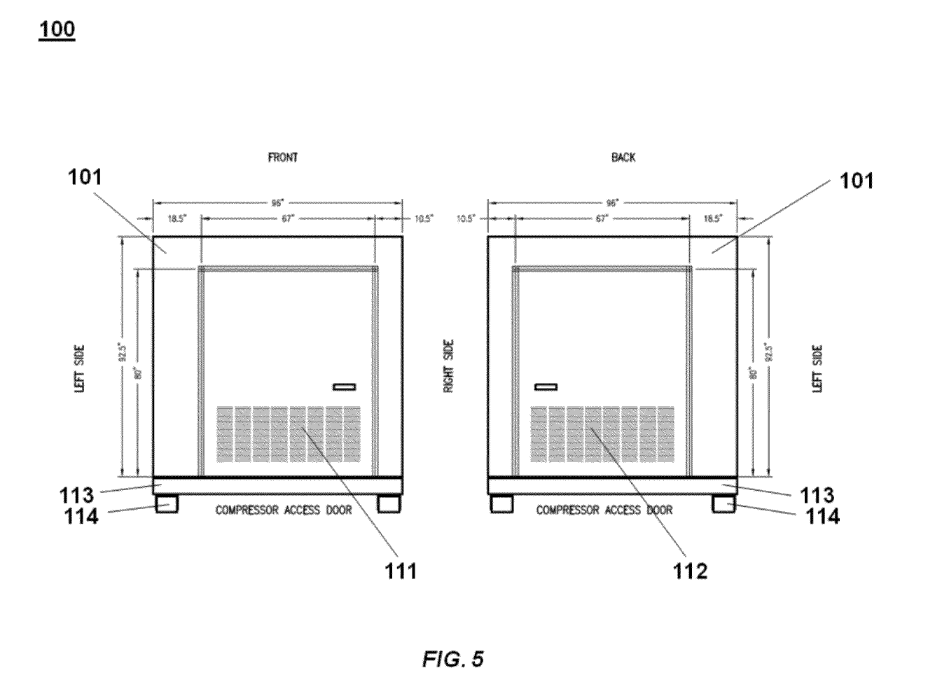

A side of the housing 101 of the refueling station 100 includes a first door 108, a second door 109, and a third door 110, as shown in FIG. 4. The first door 108 provides access to the first compressor 102, and the second door 109 provides access to the second compressor 103. The third door 110 provides access to the electronics 104. With reference to FIG. 5, a front side (left) of the housing 101 includes a fourth door 111, and a back side (right) of the housing 101 includes a fifth door 112. The fourth door 111 and fifth door 112 provide access to the second compressor 103 and first compressor 102, respectively.

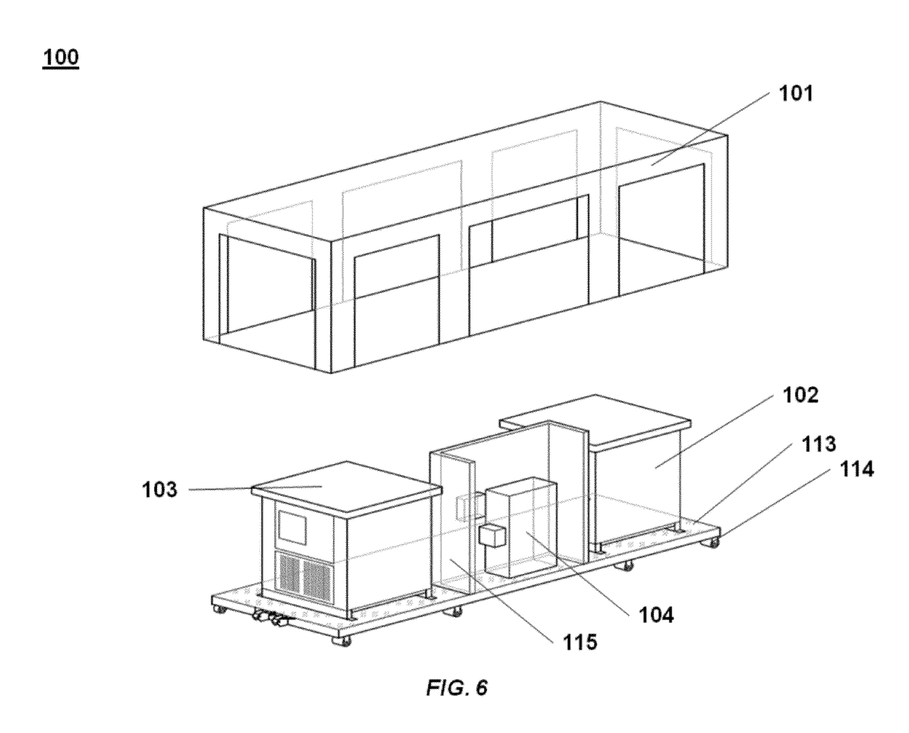

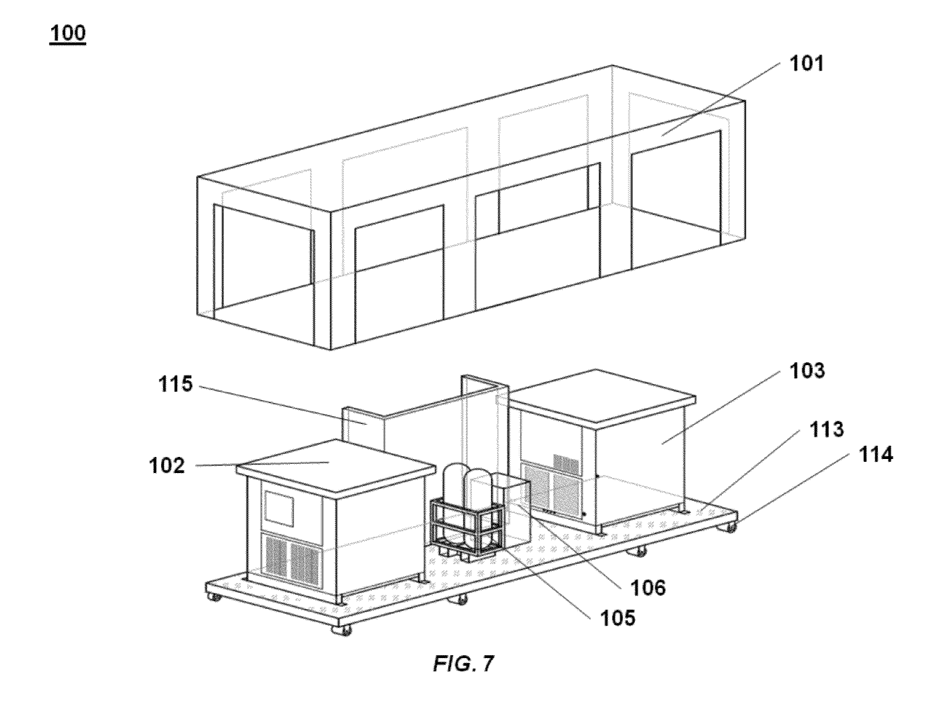

The refueling station 100 includes a support platform 113 adjacent to the housing 101, as shown in FIGS. 5-7. The refueling station 100 includes a plurality of rollers 114 adjacent to the support platform 113 to enable the refueling station 100 to be loaded onto and removed from a transport vehicle (see below). FIGS. 6 and 7 show schematic perspective isometric views of the system 100, showing the first compressor 102, second compressor 103, natural gas storage vessel 105, first dryer 106, support platform 113 and rollers 114.

In an example, the rollers 114 are spherical or semi-spherical wheels. In another example, the rollers 114 are cylindrical wheels. In another example, the rollers 114 are circular wheels. As an alternative, the rollers 114 can be replaced with other guide members, such as guide members configured to mate with guide tracks on the support platform 113.

The refueling station 100 can be adapted to protect users against an explosion and/or fire from within the housing 101. In some embodiments, the housing 101 is adapted to protect against an explosion and is tested for supporting an inside explosion. A roof of the housing 101 may be adapted to channel explosion energy from an explosion within the refueling station 100 upwardly without affecting the remaining structure. Once the doors of the refueling station 100 are closed (e.g., bolted), the housing 101 may support an inside explosion without affecting the remaining parts of the refueling station 100.

In some embodiments, if an explosion occurs or fire is detected inside the housing 101, a anti-fire sequence is operated: a fire sensor inside the housing 101 helps the electronics 104 to interpret the situation, a gas inlet valve is closed, and an outlet valve is also closed, such as, for example, to avoid the recession or backward motion of gas flowing from a gas dispenser of the refueling station 100 to one or both of the compressors 102 and 103. In some situations, gas inside the housing 101 is automatically vented through a ventilation duct to the atmosphere, and carbonic anhydride, if present, is automatically discharged inside the housing 101. The electronics 104 keeps the doors of the refueling station 101 closed to prevent contact between any fire within the housing 101 and fresh external air. In some cases, the doors are kept closed for at least about 5 minutes (“min”), 10 min, 20 min, 30 min, 40 min, 50 min, 1 hour, 2 hours, 3 hours, 4 hours, 5 hours, or 6 hours.

### Transport Vehicles

Another aspect of the present disclosure provides a transport vehicle for transporting a refueling system from a loading (or pick-up) location to a delivery location. A refueling system of the present disclosure can be loaded onto the transport vehicle, which can be used to transport the refueling system from a loading (or pick-up) location to a delivery location. At the delivery location the refueling system can be unloaded from the transport vehicle.

The transport vehicle can be a land vehicle, air vehicle, and/or sea vehicle. In an example, the transport vehicle is a car, boat, truck, train, helicopter, or airplane.

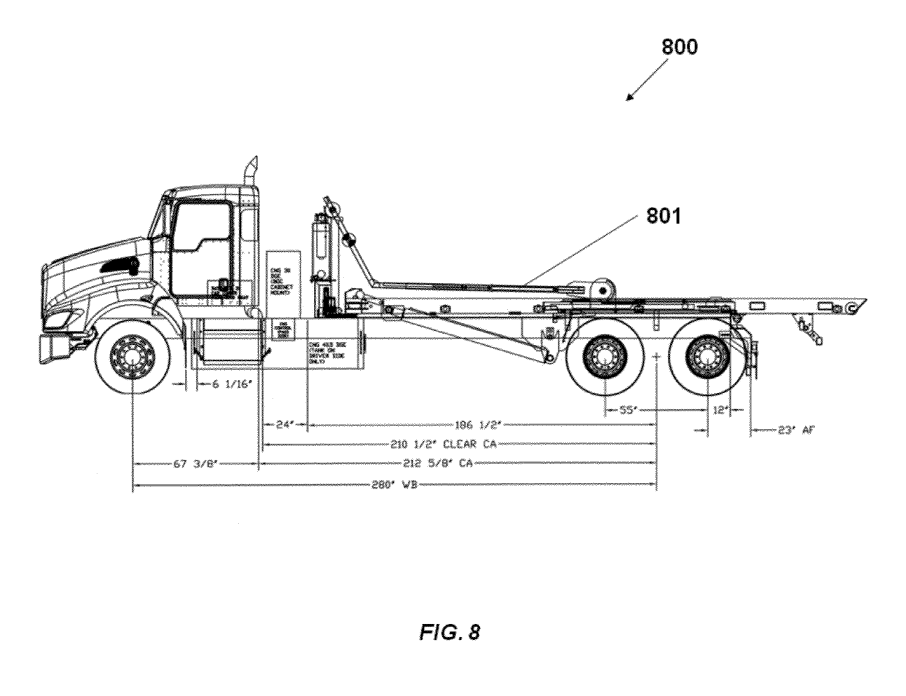

FIG. 8 shows a transport vehicle 800, in accordance with an embodiment of the present disclosure. The vehicle 800 in the illustrated example is a truck. The vehicle 800 includes a support platform 801 that is configured to hold a refueling station, such as the refueling station 100 described above. The support platform 801 is configured to incline to load and unload a refueling station. The platform can incline with the aid of an electromechanical device, such as a motor, or a hydraulic lift device.

The support platform 801 can include one or more securing members to hold or otherwise secure a refueling station against the platform 801. The securing members can hold the refueling station against the support platform 801 during movement of the transport vehicle 800. The support members can be configured to mate with the refueling station, and removed from the refueling station. In an example, the securing members are clamps that each includes one end attached to the platform 801 and another end that is engageable with the refueling station. A clamp can be dislodged from the refueling station, and the refueling station can be removed from the support platform 801.

The support platform 801 can include guides for enabling the refueling station to be rolled onto and off of the support platform. In some situations, the securing members are disposed adjacent to the guides and secure the refueling station against the support platform 801.

In some situations, a refueling station is loaded onto a transport vehicle with the aid of a \ lift device (e.g., crane). The lift device can life the refueling station from a first location and deposit refueling station on the support platform. The engagement members can be subsequently used to hold (or secure) the refueling station during transport to a delivery location. At the delivery location, the engagement members can be disengaged from the refueling station and the refueling station can be rolled off of the support platform or removed from the support platform via a sliding motion. Alternatively, the refueling station can be removed from the support platform with the aid of a life device.

In an example, the transport vehicle 800 is a rolloff (or roll off) truck with a hydraulic winch to raise and lower the platform 801. A plurality of tie down members can be used to hold the refueling station in place during transport. In some cases, the housing of the refueling station can be compatible with straps to hold refueling station in place during transport with the aid of the transport vehicle.

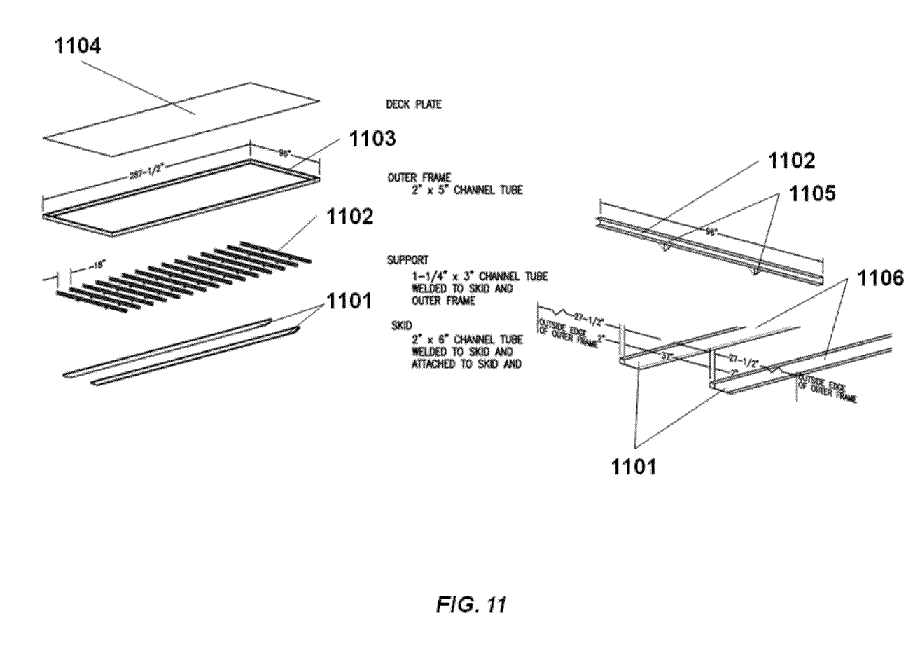

In some cases, the platform 801 can include tracks to enable a refueling station to be loaded onto or removed from the platform 801. With reference to FIG. 11, tracks 1101 (or skids) are adapted to be mounted onto a platform of a transport vehicle, such as the platform 801 of FIG. 8. A refueling station, such as the refueling station 100 of FIG. 1, can include a plurality of support members 1102 at an underside of a housing of the refueling station, which support members are adapted to be disposed adjacent to the tracks 1101. The support members 1102 can be oriented orthogonally with respect to the tracks 1101. The housing of the refueling station can include an outer plate 1103 the rests adjacent to the support members 1102, and a deck plate 1104 that rests adjacent to the outer plate 1103. The support members 1102 include each include a plurality of protrusions 1105 that are configured to be inserted into a groove 1106 of the tracks 1101. Upon loading of the refueling station onto a transport vehicle, the protrusions 1105 are adapted to mate with the grooves 1106. The tracks 1101 and support members 1102 enable the refueling station be removed from the transport vehicle in a sliding fashion—e.g., the refueling station can slide off of the tracks 1101 on the platform.

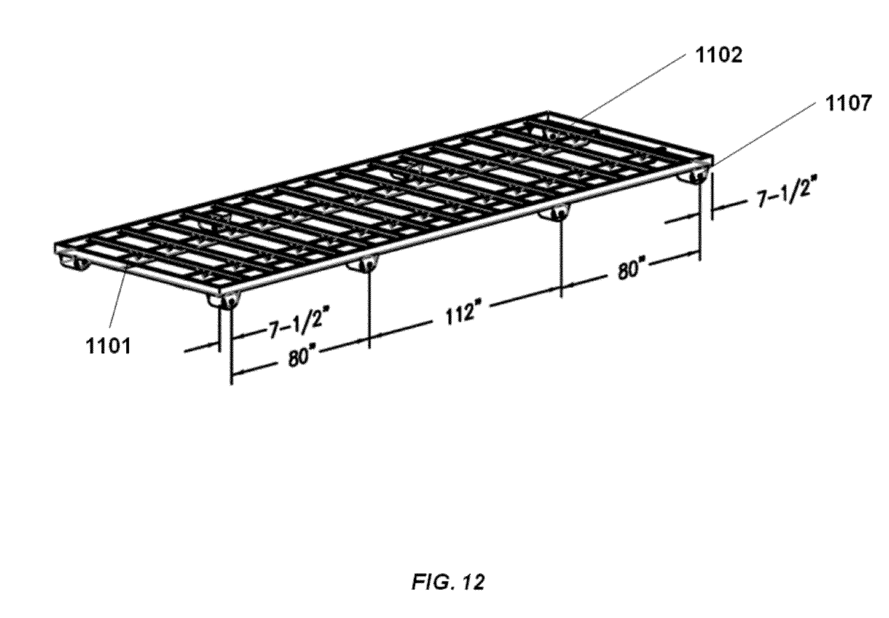

FIG. 12 shows an underside of a refueling station having the support members 1102 adjacent to the tracks 1101. The refueling station includes a plurality of rollers 1107 that enable the refueling station to rest on a support surface at a delivery or pick-up location, such as a level ground. The rollers 1107 enable the refueling station to be rolled from one point to another when the refueling station has been removed from the transport vehicle.

In some situations, with the refueling station loaded on the transport vehicle, the support members 1102 rest adjacent to the tracks 1101 and are in contact with the tracks 1101. The rollers 1007 are not in contact with the platform of the transport vehicle. The platform can be inclined to unload the refueling station. During unloading, the rollers come in contact with an unloading surface, such as a portion of ground off of, and adjacent to, the transport vehicle. With the refueling station completely unloaded from the transport vehicle, the support members are not in contact with the tracks 1101.

In some embodiments, guide members of the refueling station comprise the support members 1102 and protrusions 1105, which enable the refueling station to be loaded onto or removed from the transport vehicle.

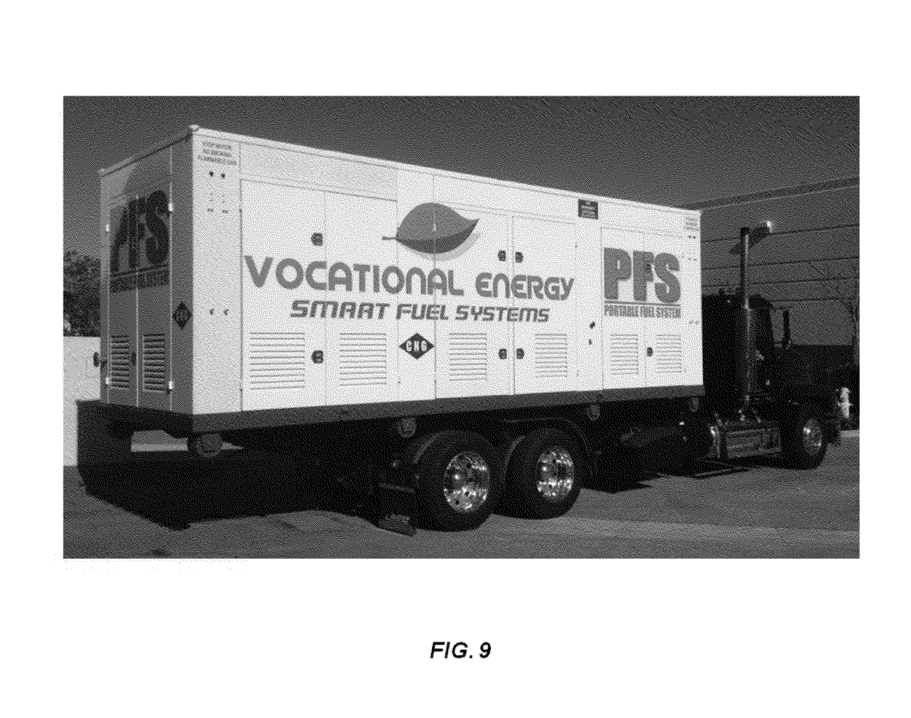

FIG. 9 is an example of a transport vehicle having a refueling station loaded on a support platform of the transport vehicle.

### Methods for Transporting Natural Gas

Another aspect of the present disclosure provides methods for loading a natural gas storage system onto a transport vehicle at a loading location, and unloading the natural gas storage system from the transport vehicle at a delivery location. The natural gas storage system can be adapted to delivery natural gas (e.g., compressed natural gas) to a user.

Natural gas storage systems provided herein can be adapted for quick loading onto a transport vehicle and unloading at a delivery location. The invention provides natural gas storage systems that can be configured for use at the delivery location within a relatively short period of time. In some cases, natural gas storage systems are ready for use at the delivery location with minimal or without any installation at the delivery location. In other cases, at least some installation may be required.

In some embodiments, at a loading location the natural gas storage system is deposited on the transport vehicle. The natural gas storage system can be deposited onto the transport vehicle in a time period of at most about 4 hours, 2 hours, 1 hour, 30 minutes, 20 minutes, 10 minutes, 5 minutes, 1 minute, or 30 seconds. The natural gas storage system can be slidably deposited on a support surface of the transport vehicle. The transport vehicle can then travel to a delivery location to deposit and, in some cases, install the natural gas storage system. In some cases, the natural gas storage system is the system 100 described above in the context of FIG. 1.

In some embodiments, at a delivery location, the natural gas storage system is slidably removed from a support surface of a transport vehicle that supports the system. The natural gas storage system can include a compressor and a natural gas storage vessel in fluid communication with said compressor. The compressor and natural gas storage vessel can be included in a housing. In some cases, the natural gas storage system is the system 100 described above in the context of FIG. 1.

In some embodiments, at the delivery location the natural gas storage system is deployed from the transport vehicle for use, which may involve any installation that may be required and subsequent delivery of natural gas to one or more users. In some situations, at the delivery location the natural gas storage system is unloaded from the transport vehicle and prepared for use in a time period less than or equal to about 4 hours, 2 hours, 1 hour, 30 minutes, 20 minutes, 10 minutes, 5 minutes, 1 minute, or 30 seconds.

The natural gas storage system can be installed at the delivery location. For instance, the natural gas storage system can be installed for use in an application selected from the group consisting of heating, power generation, fuel for combustion engines and a chemical feedstock in the manufacture of products, such as, for example, plastics and commercially viable organic chemicals.

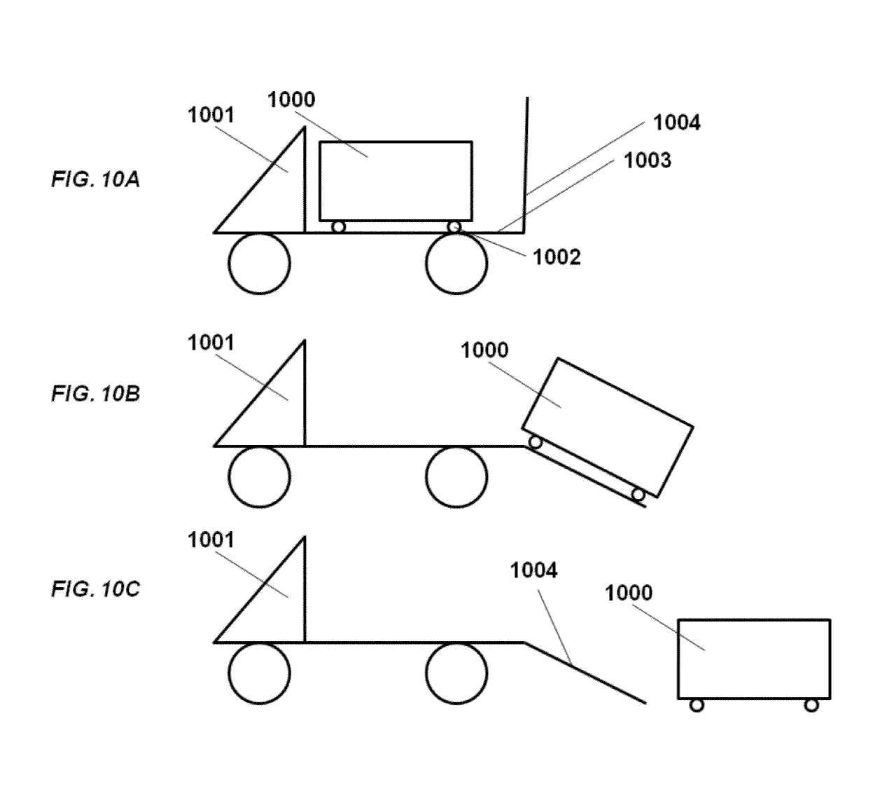

FIGS. 10A-10C schematically illustrate a method for loading a refueling station 1000 on a transport vehicle, in accordance with an embodiment of the present disclosure. The refueling station 1000 can be as described elsewhere herein, such as the refueling station 100 described above in the context of FIGS. 1-7. A plurality of guide members 1002 (e.g., rollers) of the refueling station 1000 are configured to enable the refueling station to move along a support surface 1003 of the transport vehicle 1001. Alternatively, the refueling includes support members (see, e.g., FIG. 11) at an underside of the refueling station that are adapted to mate with tracks on the support surface 1003. During loading or unloading, such support members and tracks enable the refueling station to slide on or off of the support surface 1003. The transport vehicle 1001 includes a platform 1004 that is configured to pivot to provide an incline with which the refueling station 1000 may be removed from the transport vehicle. The platform 1004 in FIG. 10A is in a reclined position.

The refueling station 1000 is initially disposed on a transport vehicle 1001, as shown in FIG. 10A. With reference to FIG. 10B, the platform 1004 is extended—such as by rotating the platform 1004 about a pivot point adjacent to the support surface 1003—and the refueling station 1000 is moved from the support surface 1003 to a portion of the platform 1004. The refueling Station 1000 can be moved with the aid of force applied to one side of the refueling station and pointed in the direction of the platform 1004. Such force can be applied with the aid of a pulley, for example. In FIG. 10C, the refueling station is removed from the platform 1004 to a location adjacent to the transport vehicle 1001. The location can be an installation site.

The refueling station 1000 can be removed from the transport vehicle 1001 with the aid of the guide members 1002. In an example, the guide members 1002 are rollers and the refueling station 1000 is removed from the transport vehicle 1001 by applying force to the refueling station 1000. The refueling station 1000 can then be rolled off of the support surface 1003 and onto the reclined platform 1004. In another example, the support surface 1003 includes tracks that mate with the guide members 1002, and the refueling station 1000 is removed from the transport vehicle by movement along the tracks.

Once the refueling station 1000 has been removed from the transport vehicle 1001, the platform 1004 can be moved to a reclined position (see FIG. 10A). In some situations, the platform is reclined by pivoting about a pivot point adjacent to the support surface 1003.

The refueling station 1000 can be loaded onto the transport vehicle by moving the refueling station 1000 along extended platform 1004 and onto the support surface 1003.

Methods and systems of the present disclosure may be combined with or modified by other methods and systems, such as, for example, methods and/or systems described in U.S. Pat. No. 6,732,769 to Del Campo (“MODULAR COMPRESSED NATURAL GAS (CNG) STATION AND METHOD FOR AVOIDING FIRE IN SUCH STATION”), which is entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A natural gas storage system, comprising a housing comprising a compressor and a natural gas storage vessel in fluid communication with said compressor, wherein said housing comprises one or more guide members for enabling the housing to be loaded onto and removed from a transport vehicle, wherein said transport vehicle removably supports said housing.

2. The natural gas storage system of claim 1, wherein said transport vehicle is a rolloff truck.

3. The natural gas storage system of claim 1, wherein said housing is removably supported on an surface of said transport vehicle that is configured to incline.

4. The natural gas storage system of claim 1, wherein said compressor is adapted to compress natural gas to a pressure between about 10 bars and 300 bars.

5. The natural gas storage system of claim 1, wherein said housing has a weight from about 10,000 lbs to 30,000 lbs.

6. The natural gas storage system of claim 1, further comprising another compressor in said housing.

7. The natural gas storage system of claim 1, wherein said guide members are rollers.

8. A method for depositing a natural gas storage system at a given location, comprising:
(a) slidably removing, at said given location, said natural gas storage system from a support surface of a transport vehicle having said natural gas storage system, wherein said natural gas storage system comprises a housing containing a compressor and a natural gas storage vessel in fluid communication with said compressor; and
(b) depositing said natural gas storage system at said given location.

9. The method of claim 8, wherein said transport vehicle is a rolloff truck.

10. The method of claim 8, wherein said compressor is adapted to compress natural gas to a pressure between about 10 bars and 300 bars.

11. The method of claim 8, wherein said given location comprises an installation area with a size of at least about 100 ft².

12. The method of claim 8, wherein said housing has a weight from about 10,000 lbs to 30,000 lbs.

13. The method of claim 8, wherein said natural gas storage system is removed from said support surface and deposited at said given location in a time period of at most about 10 minutes.

14. The method of claim 13, wherein said time period is at most about 5 minutes.

15. The method of claim 8, further comprising preparing said natural gas storage system for use at the given location, wherein said natural gas storage system is removed from said support surface, deposited at said given location and prepared for use at said given location in a time period of at most about 10 minutes.

16. A method for loading a natural gas storage system on a transport vehicle, comprising slidably loading a natural gas storage system onto a transport vehicle in a time period of at most about 10 minutes, wherein said natural gas storage system comprises a housing containing a compressor and a natural gas storage vessel in fluid communication with said compressor.

17. The method of claim 16, wherein said transport vehicle is a rolloff truck.

18. The method of claim 16, wherein said compressor is adapted to compress natural gas to a pressure between about 10 bars and 300 bars.

19. The method of claim 16, wherein said housing has a weight from about 10,000 lbs to 30,000 lbs.

20. The method of claim 16, wherein said natural gas storage system is loaded onto said transport vehicle in a time period of at most about 5 minutes.
